(19) United States
(12) Patent Application Publication
(10) Pub. No.: US 2003/0039379 A1
(43) Pub. Date: Feb. 27, 2003

(54) Method and apparatus for automatically assessing interest in a displayed product

(75) Inventors: Srinivas Gutta, Buchanan, NY (US); Vasanth Philomin, Hopewell Junction, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/935,883

(22) Filed: Aug. 23, 2001

(51) Int. Cl. G06F 17/60; G06K 9/00

(52) U.S. Cl. 382/116; 705/10

(57) ABSTRACT

A method for automatically assessing interest in a displayed product is provided. The method including: capturing image data within a predetermined proximity of the displayed product; identifying people in the captured image data; and assessing the interest in the displayed product based upon the identified people. In a first embodiment, the identifying step identifies the number of people in the captured image data and the assessing step assesses the interest in the displayed product based upon the number of people identified. In a second embodiment, the identifying step recognizes the behavior of the people in the captured image data and the assessing step assesses the interest in the displayed product based upon the recognized behavior of the people. The method can also include the step of recognizing at least one characteristic of the people identified, which can be performed with or without the assessing step.

### BACKGROUND OF THE INVENTION

1. Field of the Invention

The present invention relates generally to computer vision systems and other sensory technologies, and more particularly, to methods and apparatus for automatically assessing an interest in a displayed product through computer vision and other sensory technologies.

2. Prior Art

In the prior art there are known several ways to assess an interest in a displayed product. However, all of the known ways are manually carried out. For instance, questionnaire cards may be either available near the displayed product for passersby to take and fill-out. Alternatively, a store clerk or sales representative may solicit a person's interest in the displayed product by asking them a series of questions relating to the displayed product. However, in either way, the persons must willingly participate in the questioning. If willing, the manual questioning takes time to complete, often much more time than people are willing to spend. Furthermore, the manual questioning depends on the truthfulness of the people participating.

Additionally, manufacturers and vendors of the displayed products often want information that they'd rather not reveal to the participants, such as characteristics like gender and ethnicity. This type of information can be very useful to manufacturers and vendors in marketing their products. However, because the manufacturers perceive the participants as not wanting to supply such information or be offended by such questioning, the manufacturers and vendors do not ask such questions on their product questionnaires.

### SUMMARY OF THE INVENTION

Therefore it is an object of the present invention to provide a method and apparatus for automatically assessing an interest in a displayed product regardless of the participant's interest in participating in such an assessment.

It is another object of the present invention to provide a method and apparatus for automatically assessing an interest in a displayed product, which does not take any time of the participants of the assessment.

It is still a further object of the present invention to provide a method and apparatus for automatically assessing an interest in a displayed product, which does not depend on the truthfulness of the people participating.

It is yet still a further object of the present invention to provide a method and apparatus for non-intrusively compiling sensitive marketing information regarding people interested in a displayed product.

Accordingly, a method for automatically assessing interest in a displayed product is provided. The method generally comprises: capturing image data within a predetermined proximity of the displayed product; identifying people in the captured image data; and assessing the interest in the displayed product based upon the identified people.

In a first embodiment of the methods of the present invention, the identifying step identifies the number of people in the captured image data and the assessing step assesses the interest in the displayed product based upon the number of people identified.

In a second embodiment of the methods of the present invention, the identifying step recognizes the behavior of the people in the captured image data and the assessing step assesses the interest in the displayed product based upon the recognized behavior of the people. The recognized behavior is preferably at least one of the average time spent in the predetermined proximity of the displayed product, the average time spent looking at the displayed product, the average time spent touching the displayed product, and the facial expression of the identified people.

Preferably, the methods of the present invention further comprise recognizing at least one characteristic of the people identified in the captured image data. Such characteristics preferably include gender and ethnicity.

Also provided is a method for assessing interest in a displayed product. The method comprising: recognizing speech of people within a predetermined proximity of the displayed product; and assessing the interest in the displayed product based upon the recognized speech.

Also provided is a method for compiling data of at least one characteristic of people within a predetermined proximity of a displayed product. The method comprises; capturing image data within the predetermined proximity of the displayed product; identifying the people in the captured image data; and recognizing at least one characteristic of the people identified. Preferably, the at least one characteristic is chosen from a list consisting of gender and ethnicity.

In the method for compiling data of at least one characteristic of people within a predetermined proximity of a displayed product, the method preferably further comprises: identifying the number of people in the captured image data; and assessing interest in the displayed product based upon the number of people identified.

In the method for compiling data of at least one characteristic of people within a predetermined proximity of a displayed product, the method preferably further comprises: recognizing the behavior of the people identified in the captured image data; and assessing interest in the displayed product based upon the recognized behavior of the people identified. Preferably, the recognized behavior is at least one of the average time spent in the predetermined proximity of the displayed product, the average time spent looking at the displayed product, the average time spent touching the displayed product, and the facial expression of the identified people.

Also provided is an apparatus for automatically assessing interest in a displayed product. The apparatus comprises: at least one camera for capturing image data within a predetermined proximity of the displayed product; identification means for identifying people in the captured image data; and means for assessing the interest in the displayed product based upon the identified people.

In a first embodiment, the identification means comprises means for identifying the number of people in the captured image data and the means for assessing assesses the interest in the displayed product based upon the number of people identified.

In a second embodiment, the identification means comprises means for recognizing the behavior of the people identified in the captured image data and the means for assessing assesses the interest in the displayed product based upon the recognized behavior.

Preferably, the apparatus further comprises recognition means for recognizing at least one characteristic of the people identified in the captured image data.

Also provided is an apparatus for assessing interest in a displayed product. The apparatus comprising: at least one microphone for capturing audio data of people within a predetermined proximity of the displayed product; means for recognizing speech of people from the captured audio data; and means for assessing the interest in the displayed product based upon the recognized speech.

Further provided is an apparatus for compiling data of at least one characteristic of people within a predetermined proximity of a displayed product. The apparatus comprises; at least one camera for capturing image data within a predetermined proximity of the displayed product; identifying the people within the captured image data; and recognizing at least one characteristic of the people identified.

Still yet provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a flowchart of a preferred implementation of the methods of the present invention for assessing interest in a displayed product.

FIG. 2 illustrates a flowchart of a preferred implementation of an alternative method of the present invention for assessing interest in a displayed product.

FIG. 3 illustrates a schematic representation of an apparatus for carrying out the preferred methods of FIG. 1.

### DETAILED DESCRIPTION OF THE PREFERRED EMBODIMENT

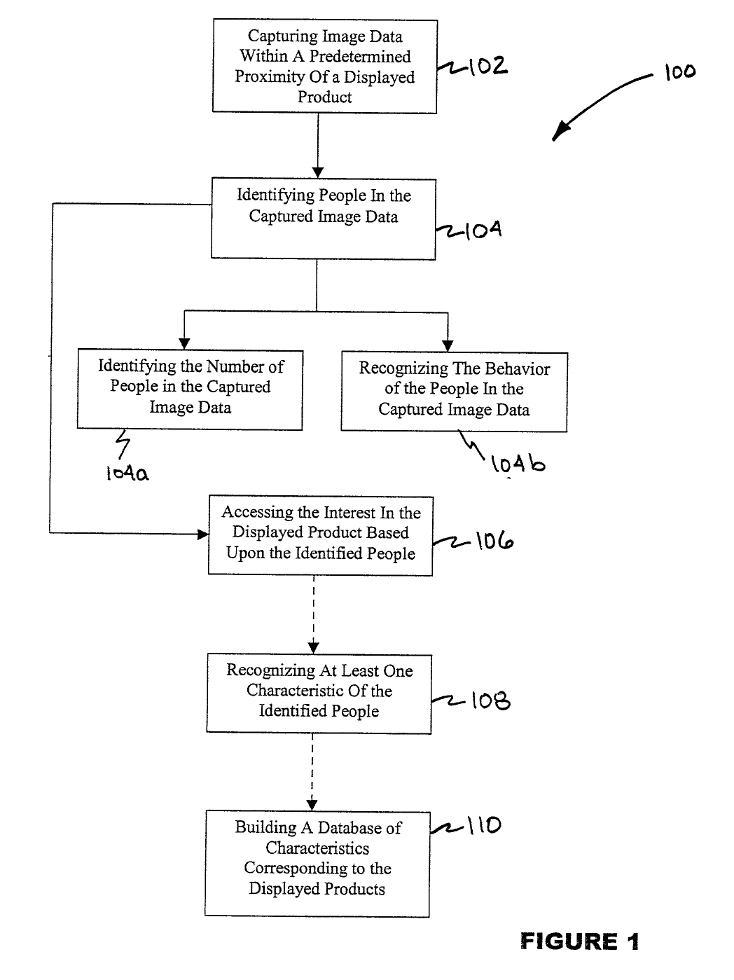

Referring first to FIG. 1, there is illustrated a flowchart illustrating a preferred implementation of the methods for automatically assessing interest in a displayed product, the method being generally referred to by reference numeral 100. At step 102, image data is captured within a predetermined proximity of the displayed product. At step 104 people in the captured image data are identified.

After the people are identified in the captured image data, the interest in the displayed product is assessed at step 106 based upon the identified people. In a first preferred implementation of the methods 100 of the present invention, the identifying step 104 comprises identifying the number of people in the captured image data (shown as step 104a). In which case, the assessing step 106 assesses the interest in the displayed product based upon the number of people identified. In a second preferred implementation of the methods 100 of the present invention, the identifying step 104 comprises recognizing the behavior of the people in the captured image data (shown as step 104b). In which case, the assessing step 106 assesses the interest in the displayed product based upon the recognized behavior of the people.

Alternatively, at step 108, the methods 100 of the present invention can also recognize at least one characteristic of the people identified in the captured image data. At step 110, the recognized characteristics can be used to build a database in which the characteristics are related to the displayed product or product type. Steps 108 and 110 are alternatives to the other method steps shown in the flowchart of FIG. 1 and can also be practiced independently of the other steps, save steps 102 and 104 in which the image data within the predetermined proximity of the displayed product is captured and the people therein are identified.

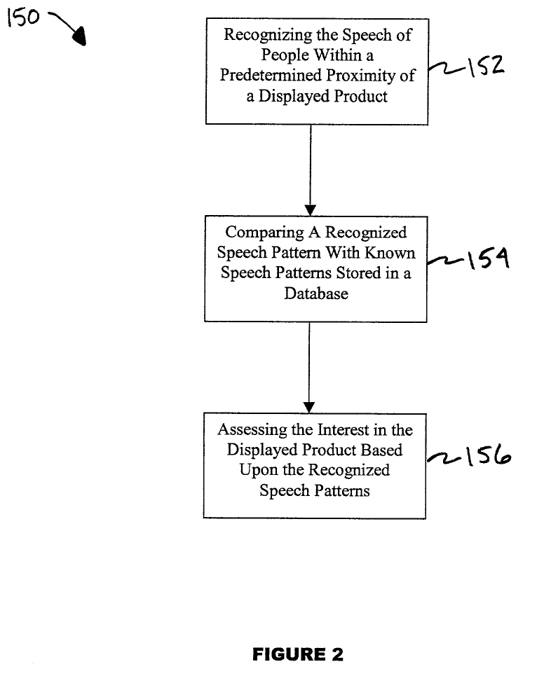

Referring now to FIG. 2, there is shown an alternative embodiment for assessing interest in a displayed product, the method being generally referred to by reference numeral 150. Method 150 includes recognizing speech of the people within the predetermined proximity of the displayed product at step 152. After which, an assessment of the interest in the displayed product is made at step 156 based upon the recognized speech. Preferably, at step 154, the recognized speech is compared to database entries, which have degrees of interest designations corresponding thereto.

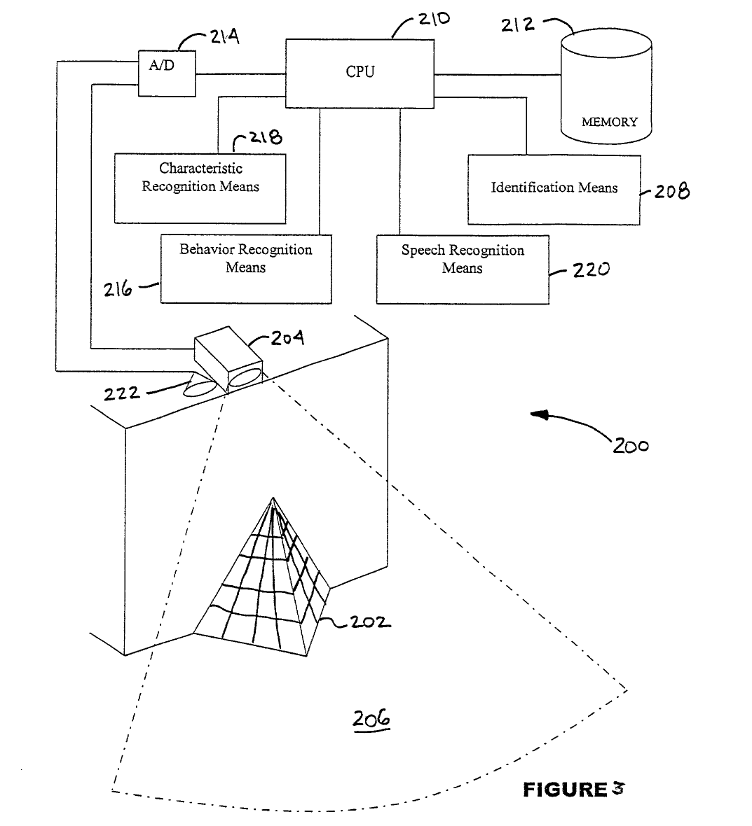

The apparatus for carrying out the methods 100 of the present invention will now be described with reference to FIG. 3. FIG. 3 illustrates a preferred implementation of an apparatus for automatically assessing interest in a displayed product, the apparatus being generally referred to by reference numeral 200. The displayed product is illustrated therein as a half pyramid of stacked products supported by a wall 203 and generally referred to by reference numeral 202. However, the displayed products 202 are shown in such a configuration by way of example only and not to limit the scope or spirit of the invention. For example, the displayed products 202 can be stacked in any shape, can be stacked in a free-standing display, or can be disposed on a shelf or stand.

Apparatus 200 includes at least one camera 204 for capturing image data within a predetermined proximity of the displayed product. The term camera 204 is intended to mean any image capturing device. The camera 204 can be a still camera or have pan, tilt and zoom (PTZ) capabilities. Furthermore, the camera 204 can capture video image data or a series of still image data frames. In the situation where the displayed products 202 are accessible from a single side, generally only one camera 204 is needed with a sufficient field of view (FOV) such that any person approaching or gazing at the displayed product 202 will be captured in the image data. However, some product display configurations, such as a freestanding pyramid or tower may require more than one camera 204. In such an instance, it is well known in the art how to process image data to eliminate or ignore overlap between the image data from more than one image data capturing device.

The predetermined proximity 206 within which the image data is captured can be fixed by any number of means. Preferably, the predetermined proximity 206 is fixed as the FOV of the camera 204. However, other means may be provided for determining the predetermined proximity 206. For instance, optical sensors (not shown) can be utilized to “map” an area around the displayed product 202.

Apparatus 200 also includes an identification means 208 for identifying people in the captured image data. Preferably, the captured image data is input to the identification means 208 through a central processor (CPU) 210 but may be input directly into the identification means 208. The captured image data can be analyzed to identify people therein “on the fly” in real-time or can first be stored in a memory 212 operatively connected to the CPU. If the captured image data is analog data it must first be digitized through an analog to digital (A/D) converter 214. Of course, an A/D converter 214 is not necessary if the captured image data is digital data. Identification means for identifying humans is well known in the art and generally recognize certain traits that are unique to humans, such as gait. One such identification means is disclosed in J. J. Little and J. E. Boyd, Recognizing People by their Gait: The Shape of Motion, Journal of Computer Vision Research, Vol. 1(2), pp. 1-32, Winter, 1998.

Apparatus 200 further includes means for assessing the interest in the displayed product 202 based upon the identified people in the captured image data. Many different criteria can be used to make such an assessment based on the identification of people in the captured image data (i.e., within the predetermined proximity).

In a first preferred implementation, the identification means 208 comprises means for identifying the number of people in the captured image data. In which case, the means for assessing assesses the interest in the displayed product 202 based upon the number of people identified. In such an implementation, upon identification of each person, a counter is incremented and the number is preferably stored in memory, such as in memory 212. The assessing means is preferably provided by the CPU 210, into which the number is input, and manipulated to output a designation of interest. In a simplest manipulation, the CPU 210 merely outputs the total number of people identified per elapsed time (e.g., 25 people/minute). The idea behind the first implementation is that the more people near the displayed product 202, the more interest there must be in the product 202.

In a second preferred implementation, the obvious flaws in the first implementation are addressed. For example, in the first implementation discussed above, it is assumed that the people identified as being within the predetermined proximity must be interested in the displayed product 202 and not simply “passing through.” Thus, in the second preferred implementation of the methods 100 of the present invention, the identification means 208 comprises behavior recognition means 216 for recognizing the behavior of the people identified in the captured image data. In which case, the means for assessing assesses the interest in the displayed product 202 based, in whole or in part, upon the recognized behavior.

For instance, behavior recognition means 216 can recognize the average time spent in the predetermined proximity 206 of the displayed product 202. Therefore, those people who are merely “passing through” can be eliminated or weighted differently in the determination of assessing interest in the displayed product 202. For example, given the distance of the predetermined proximity 206 and the average walking speed of a human an average time to traverse the predetermined proximity 206 can be calculated. Those people identified who spend more time in the predetermined proximity 206 than the calculated average time would be either eliminated or weighted less in the assessment of interest. The CPU 210 would also be capable of making such an assessment given the appropriate instructions and inputs.

As another example of behavior, the behavior recognition means 216 can recognize the average time spent looking at the displayed product 202. Recognition means 214 for recognizing “facial head pose” of identified people is well known in the art, such as that disclosed in S. Gutta, J. Huang, P. J. Phillips and H. Wechsler, Mixture of Experts for Classification of Gender, Ethnic Origin and Pose of Human Faces, IEEE Transactions on Neural Networks, Vol. 11(4), pp. 948-960, July 2000.

In such a case, those people who are identified in the captured image data who do not look at the product while in the predetermined proximity are either eliminated or given less weight in the assessment of interest in the displayed product 202. Furthermore, the length of time spent looking at the displayed product 202 can be use as a weighting factor in making the assessment of product interest. The idea behind this example is that those people looking at the displayed product 202 for a sufficient amount of time are more interested in the product than those people who merely peak at the product for a short time or who do not look at the product at all. As discussed above, the CPU 210 would also be capable of making such an assessment given the appropriate instructions and inputs.

Yet another example of behavior that can be recognized by the behavior recognition means 216 and used in making the assessment of product interest is the average time spent touching the displayed product 202. Recognition systems for recognizing an identified person touching another identified object (i.e., the displayed products) are well known in the art, such as those using a “connected component analysis.” In such a case, those people who are identified in the captured image data who do not touch the product are either eliminated or given less weight in the assessment of interest in the displayed product 202. Furthermore, the length of time spent touching (which could also be further classified as a holding of the product if sufficiently long enough) the displayed product 202 can be use as a weighting factor in making the assessment of product interest. The idea behind this example is that those people who actually stop to touch or hold the displayed product 202 for a sufficient amount of time must be interested in the product. As discussed above, the CPU 210 would also be capable of making such an assessment given the appropriate instructions and inputs.

Still yet another example of behavior that can be recognized by the behavior recognition means 216 and used in making the assessment of product interest is the facial expression of the people identified in the captured image data. Recognition systems for recognizing an identified person's facial expression are known in the art, such as that disclosed in co-pending U.S. application Ser. No. 09/705,666, titled “Estimation of Facial Expression Intensity using a Bi-Directional Star Topology Hidden Markov Model” and filed on Nov. 13, 2000. In such a case, certain facial expressions can correspond with a degree of interest in the displayed products 202. For instance, a surprised facial expression can correspond to great interest, a smile in some interest, and a blank look in little interest. As discussed above, the CPU 210 would also be capable of making such an assessment given the appropriate instructions and inputs.

FIG. 3 also illustrates an alternative embodiment for assessing the interest in the displayed products that can be used in combination with the identification means 208 and behavior recognition means 216 discussed above, or as a sole means for assessing product interest. Apparatus 200 also preferably includes a speech recognition means 220 for recognizing the speech of people within the predetermined proximity 206 through at least one appropriately positioned microphone 222. Although a single microphone should be sufficient in most instances, more than one microphone can be used. In the case of the speech recognition, the predetermined proximity 206 is preferably determined from the pick-up range of the at least one microphone 222. Preferably, the recognized speech is compared by the CPU 210 to database entries of known speech patterns in the memory 212. Each of the known speech patterns preferably have a degree of interest associated with it. If a recognized speech pattern matches a data base entry, the corresponding degree of interest is output.

The means for assessing the interest in the product can be very simple as discussed above or can be complicated by using several recognized behaviors and assigning a weighting factor or other manipulation to each to make a final assessment of the product interest. For instance, the assessing means can use the number of people identified, the average time spent, the average time spent looking at the product, the average time spent touching the product, the facial expression of the identified people in its assessment, and the recognition of a known speech pattern and assign an increasing weight of importance from former to latter. Whatever the criteria used, the assessing means could then output a designation of product interest such as very interested, interested, not so interested, or little interest. Alternatively, the assessing means can output a number designation, such as 90, which can be compared to a scale, such as 0-100. The assessing means can also output a designation, which is used in comparison to the designation of interest of other well-known products. For example, the interest designation of an earlier model of a product or a similar competitor's model could be compared to that of the displayed product.

As discussed above, the methods of the present invention can be supplemented with a characteristic recognition means 218 for recognizing at least one characteristic of the people identified in the captured image data. As also discussed above, the recognition of a characteristic of the people identified in the captured image data can also stand alone and not be part of a system which assesses interest in a displayed product 202.

Characteristics that can be recognized by the characteristic recognition means 218 include gender and/or ethnicity of the identified people in the captured image data. Other characteristics can also be recognized by the characteristic recognition means, such as hair color, body type, etc. Recognition of such characteristics is well known in the art, such as by the system disclosed in S. Gutta, J. Huang, P. J. Phillips and H. Wechsler, Mixture of Experts for Classification of Gender, Ethnic Origin and Pose of Human Faces, IEEE Transactions on Neural Networks, Vol. 11(4), pp. 948-960, July 2000.

As discussed above, the data from the characteristic recognition means 218 can be compiled in a database and used by manufacturers and vendors in marketing their products. For instance, through the methods of the present invention, it can be determined that people of a certain ethnicity are interested in a displayed product. The manufacturers and/or vendors of that product can then either decide to tailor their advertisements to reach that particular ethnicity or can tailor their advertisements so to interest people of other ethnicities.

As with the identification recognition means 208, the behavior and characteristic recognition means 216, 218 can operate directly from the captured image data or preferably through a CPU 210, which has access to the captured image data stored in memory 212. The identification recognition means 208, behavior recognition means 216, and characteristic recognition means 218 may also all have their own processors and memory or share the same with the CPU 210 and memory 212. Although not shown as such, CPU 210 and memory 212 are preferably part of a computer system also having a display, input means, and output means. The memory 212 preferably contains program instructions for carrying out the people identification, behavior recognition and characteristic recognition of the methods 100 of the present invention.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for automatically assessing interest in a displayed product, the method comprising:
capturing image data within a predetermined proximity of the displayed product;
identifying people in the captured image data; and
assessing the interest in the displayed product based upon the identified people.

2. The method of claim 1, wherein the identifying step identifies the number of people in the captured image data and the assessing step assesses the interest in the displayed product based upon the number of people identified.

3. The method of claim 1, wherein the identifying step recognizes the behavior of the people in the captured image data and the assessing step assesses the interest in the displayed product based upon the recognized behavior of the people.

4. The method of claim 3, wherein the recognized behavior is at least one of the average time spent in the predetermined proximity of the displayed product, the average time spent looking at the displayed product, the average time spent touching the displayed product, and the facial expression of the identified people.

5. The method of claim 1, further comprising recognizing at least one characteristic of the people identified in the captured image data.

6. The method of claim 5, wherein the at least one characteristic is chosen from a list consisting of gender and ethnicity.

7. A method for compiling data of at least one characteristic of people within a predetermined proximity of a displayed product, the method comprising;
capturing image data within the predetermined proximity of the displayed product;
identifying the people in the captured image data; and
recognizing at least one characteristic of the people identified.

8. The method of claim 7, wherein the at least one characteristic is chosen from a list consisting of gender and ethnicity.

9. The method of claim 7, further comprising:
identifying the number of people in the captured image data; and
assessing interest in the displayed product based upon the number of people identified.

10. The method of claim 7, further comprising:
recognizing the behavior of the people identified in the captured image data; and
assessing interest in the displayed product based upon the recognized behavior of the people identified.

11. The method of claim 10, wherein the recognized behavior is at least one of the average time spent in the predetermined proximity of the displayed product, the average time spent looking at the displayed product, the average time spent touching the displayed product, and the facial expression of the identified people.

12. A method for assessing interest in a displayed product, the method comprising:
recognizing speech of people within a predetermined proximity of the displayed product; and
assessing the interest in the displayed product based upon the recognized speech.

13. An apparatus for automatically assessing interest in a displayed product, the apparatus comprising:
at least one camera for capturing image data within a predetermined proximity of the displayed product;
identification means for identifying people in the captured image data; and
means for assessing the interest in the displayed product based upon the identified people.

14. The apparatus of claim 13, wherein the identification means comprises means for identifying the number of people in the captured image data and the means for assessing assesses the interest in the displayed product based upon the number of people identified.

15. The apparatus of claim 13, wherein the identification means comprises means for recognizing the behavior of the people identified in the captured image data and the means for assessing assesses the interest in the displayed product based upon the recognized behavior.

16. The apparatus of claim 13, further comprising recognition means for recognizing at least one characteristic of the people identified in the captured image data.

17. An apparatus for compiling data of at least one characteristic of people within a predetermined proximity of a displayed product, the apparatus comprising;
at least one camera for capturing image data within a predetermined proximity of the displayed product;
identifying the people within the captured image data; and
recognizing at least one characteristic of the people identified.

18. An apparatus for assessing interest in a displayed product, the apparatus comprising:
at least one microphone for capturing audio data of people within a predetermined proximity of the displayed product;
means for recognizing speech of people from the captured audio data; and
means for assessing the interest in the displayed product based upon the recognized speech.

19. A computer program product embodied in a computer-readable medium for automatically assessing interest in a displayed product, the computer program product comprising:
computer readable program code means for capturing image data within a predetermined proximity of the displayed product;
computer readable program code means for identifying people in the captured image data; and
computer readable program code means for assessing the interest in the displayed product based upon the identified people.

20. A computer program product embodied in a computer-readable medium for compiling data of at least one characteristic of people within a predetermined proximity of a displayed product, the computer program product comprising;
computer readable program code means for capturing image data within the predetermined proximity of the displayed product;
computer readable program code means for identifying the people in the captured image data; and
computer readable program code means for recognizing at least one characteristic of the people identified.

21. A computer program product embodied in a computer-readable medium for assessing interest in a displayed product, the method comprising:
computer readable program code means for recognizing speech of people within a predetermined proximity of the displayed product; and
computer readable program code means for assessing the interest in the displayed product based upon the recognized speech.

22. A program storage device readable by machine, tangibly embodying a program of instructions executable by the machine to perform method steps for automatically assessing interest in a displayed product, the method comprising:
capturing image data within a predetermined proximity of the displayed product;
identifying people in the captured image data; and
assessing the interest in the displayed product based upon the identified people.

23. A program storage device readable by machine, tangibly embodying a program of instructions executable by the machine to perform method steps for compiling data of at least one characteristic of people within a predetermined proximity of a displayed product, the method comprising;
capturing image data within the predetermined proximity of the displayed product;
identifying the people in the captured image data; and
recognizing at least one characteristic of the people identified.

24. A program storage device readable by machine, tangibly embodying a program of instructions executable by the machine to perform method steps for assessing interest in a displayed product, the method comprising:
recognizing speech of people within a predetermined proximity of the displayed product; and
assessing the interest in the displayed product based upon the recognized speech.
